(19) United States
(12) Patent Application Publication
(10) Pub. No.: US 2010/0208638 A1
(43) Pub. Date: Aug. 19, 2010

(54) WIRELESS COMMUNICATION APPARATUS AND TRANSMISSION CONTROL METHOD THEREOF

(76) Inventor: Satoshi Kawaji, Yokohama-shi (JP)

Correspondence Address: MORRISON & FOERSTER LLP, 12531 HIGH BLUFF DRIVE, SUITE 100, SAN DIEGO, CA, 92130-2040, US

(21) Appl. No.: 12/680,136

(22) PCT Filed: Sep. 24, 2008
(86) PCT No.: PCT/JP2008/067180

§ 371 Date: Mar. 25, 2010

(30) Foreign Application Priority Data
Sep. 26, 2007 (JP) 2007-249802

(51) Int. Cl. G08C 17/00

(52) U.S. Cl. 370/311

(57) ABSTRACT

A wireless communication apparatus for transmitting a multi-carrier modulated signal is provided with at least two amplification paths A1, A2 with different power consumption and capable of amplifying the modulated signal, selection units 15, 16 for selecting one of the at least two amplification paths A1, A2, and a control unit 3 for controlling the selection units 15, 16 to select one of the amplification paths in accordance with the number of subcarriers in the modulated signal and a selected amplification path to amplify the modulated signal. It thereby efficiently reduces power consumption.

### CROSS REFERENCE TO RELATED APPLICATION

This application claims priority to and the benefit of Japanese Patent Application No. 2007-249802 filed on Sep. 26, 2007, the entire contents of which are incorporated herein by reference.

### TECHNICAL FIELD

The present invention relates to a wireless communication apparatus for transmitting multi-carrier modulated signals and a transmission control method of the wireless communication apparatus.

### BACKGROUND ART

Presently, a so-called wireless broadband having a large communication capacity has been considered actively in a wireless communication field. A known system as one of systems of the wireless broadband is WiMAX (Worldwide Interoperability for Microwave Access), for example, which is defined in IEEE (Institute of Electrical and Electronic Engineers) 802.16 standard (for example, see Non-Patent Document 1).

WiMAX system adopts OFDM (Orthogonal Frequency Division Multiplexing) using multi-carrier as a modulation scheme. In addition, IEEE 802.16e standard provided with mobility adopts OFDMA (Orthogonal Frequency Division Multiple Access) as a multiple access scheme.

Here, an OFDM signal is generated by combining a plurality of digital modulation signals with different subcarrier frequencies, each of which is formed of a sinusoidal wave. Hence, a baseband OFDM signal has a noise-like waveform, which more randomly fluctuates as the number of subcarriers increases, as shown in FIGS. 6(a) to 6(d). FIGS. 6(a) to 6(d) show waveforms when combining the subcarriers of the sinusoidal waves with different frequencies. FIG. 6(a) shows the waveform when the number of subcarriers N is 2, FIG. 6(b) shows the waveform when the N is 4, FIG. 6(c) shows the waveform when the N is 8, and FIG. 6(d) shows the waveform when the N is 16.

As obvious from FIGS. 6(a) to 6(d), as the number of subcarriers increases, the combined waveform becomes more complex and an instantaneous value and PAPR

(Peak to Average Power Ratio) of a signal increase. For an actual OFDM signal, each subcarrier has a phase and/or an amplitude component depending on the modulation scheme and, moreover, since the number of subcarriers increases depending on the bandwidth or an FFT (Fast Fourier Transform) size, PAPR increases even more. For example, for a system with the bandwidth of 10 MHz and the FFT size of 1024, PAPR indicates a high value, approximately 13 dB.

Hence, it is necessary to design a power amplifier for transmitting the OFDM signal so as to maintain amplification characteristics of high linearity and a large backoff, to prevent an output signal from being distorted by a nonlinear area or being radiated as a spurious outside the bandwidth and interfering with signals in an adjacent channel or other systems.

Non-Patent Document 1: Takeshi Hattori and Masanobu Fujioka, “Impress Standard Textbook Series, Wireless Broadband Textbook revised edition, High Speed IP Wireless Edition” first edition, Impress R&D Company, June 2006, pages 199-212

### SUMMARY OF INVENTION

### Technical Problem

However, in general, there is a correlation between the backoff and a power efficiency of the power amplifier, and a larger backoff lowers the power efficiency. That is, in order to secure the large backoff, it is necessary to ensure linearity to a range corresponding to the backoff for actually transmitted power (average power). Thus, it requires to use the power amplifier with high power consumption (hereinafter, referred to also as power usage), which degrades the power efficiency.

For example, the multiple access scheme of OFDMA adopted by IEEE802.16e has a feature to be able to determine a bandwidth to be used and a duration in accordance with a communication condition, usage and the likes. Accordingly, the number of subcarriers may be smaller than a maximum number of subcarriers, depending on a condition such as an application, traffic and the likes.

In such a case as the number of subcarriers is small, PAPR of the signal becomes small and there is no hindrance in communication when the backoff of the power amplifier is small. It is thus possible to have a power saving mode by lowering the linearity of the power amplifier.

For a conventional wireless communication apparatus, however, linearity and backoff of the power amplifier are fixed such that the OFDM signal satisfies the standard, that is, so as to correspond to the maximum number of sable subcarriers.

Consequently, since power efficiency of the power amplifier is low even when the number of subcarriers used is small, the power consumption is increased and, especially for a mobile communication terminal powered by a battery, there is concern that it shortens the run time of the battery.

Thus, an object of the present invention in consideration of such circumstances is to provide a wireless communication apparatus using a multi-carrier modulation scheme capable of reducing power consumption and the transmission control method of the wireless communication apparatus.

### Solution to Problem

In order to achieve the above object, a wireless communication apparatus for transmitting a multi-carrier modulated signal according to a first aspect of the present invention includes:

at least two amplification paths with different power consumption and capable of amplifying the modulated signal;

a selection unit for selecting one of the at least two amplification paths; and

a control unit for controlling the selection unit to select one of the amplification paths in accordance with the number of subcarriers in the modulated signal and a selected amplification path to amplify the modulated signal.

A second aspect of the present invention is that the wireless communication apparatus according to the first aspect further includes a memory unit for storing an amplification path to be used in accordance with the number of subcarriers,

wherein the control unit controls the selection unit to select a corresponding amplification path stored in the memory unit, in accordance with the number of subcarriers in the modulated signal.

A third aspect of the present invention is that in the wireless communication apparatus according to the first aspect,

the control unit controls the selection unit to select one of the amplification paths in accordance with the number of subcarriers and transmission power for transmitting the modulated signal.

A fourth aspect of the present invention is that in the wireless communication apparatus according to the first aspect,

among the at least two amplification paths with different power consumption, an amplification path with less power consumption has an amplification characteristic of lower linearity than that of an amplification path with more power consumption.

A fifth aspect of the present invention is that in the wireless communication apparatus according to the first aspect,

among the at least two amplification paths with different power consumption, an amplification path with more power consumption has an amplification characteristic of higher linearity than that of an amplification path with less power consumption.

Moreover, in order to achieve the above object, a transmission control method of a wireless communication apparatus for transmitting a multi-carrier modulated signal according to a sixth aspect of the present invention includes:

an amplification path selection step for selecting one amplification path or another amplification path with less power consumption than the one amplification path to amplify the modulated signal in accordance with the number of subcarriers in the modulated signal; and

a modulated signal amplification step for amplifying the modulated signal by a selected amplification path.

### Advantageous Effects on Invention

According to the present invention, an amplification path is selected to amplify the multi-carrier modulated signal between one amplification path or another amplification path with less power consumption than the one amplification path, in accordance with the number of subcarriers in the modulated signal. It is thus possible to achieve a wireless communication apparatus adopting a multi-carrier modulation scheme suitable to reduce power consumption and a transmission control method of the wireless communication apparatus, capable of efficiently reducing power consumption without negatively affecting the communication.

### BRIEF DESCRIPTION OF DRAWINGS

FIG. 1 is a block diagram illustrating a constitution of a main section of a wireless communication apparatus according to a first embodiment of the present invention;

FIG. 2 is a functional block diagram illustrating a constitution of a main section of a control unit shown in FIG. 1;

FIG. 3 is a flow chart describing operations of the wireless communication apparatus according to the first embodiment;

FIG. 4 is a block diagram illustrating a constitution of a main section of a wireless communication apparatus according to a second embodiment of the present invention;

FIG. 5 is a block diagram illustrating a constitution of a main section of a wireless communication apparatus according to a third embodiment of the present invention; and

FIG. 6 is graphs showing four OFDM signal waveforms with different number of subcarriers.

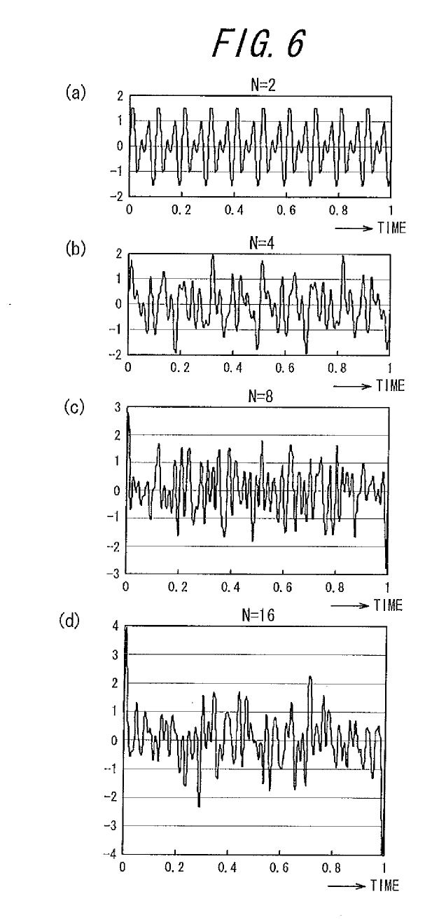

### REFERENCE SIGNS LIST

1 power amplifier module
2 memory unit
3 control unit
11, 12, 13, 14 amplifier
15, 16 switch
21 subcarrier number information reception unit
22 amplification path determination unit
23 amplification path control unit
25 power amplifier module
31 power amplifier module
32, 33, 34, 35, 36, 37 amplifier
38, 39 switch
A1 first amplification path
A2 second amplification path

### Description of Embodiments

Embodiments of the present invention will be described with reference to the accompanying drawings.

### First Embodiment

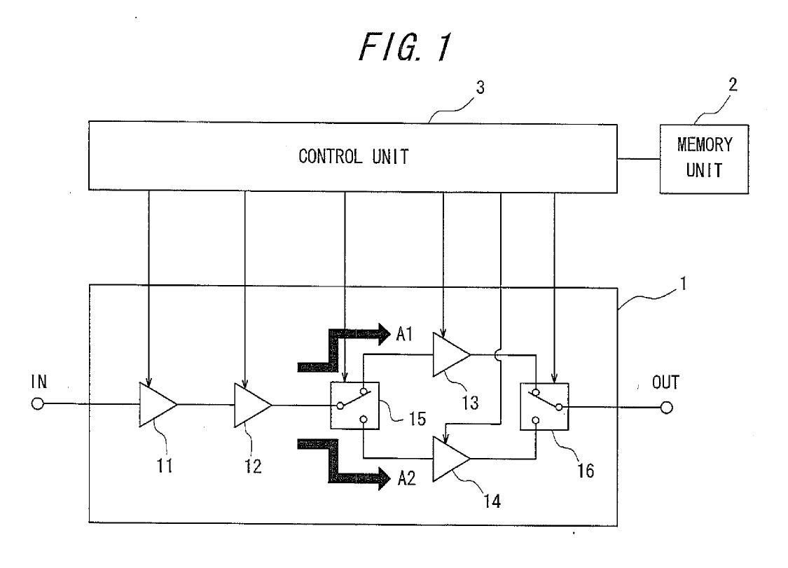

FIG. 1 is a block diagram illustrating a constitution of a main section of a wireless communication apparatus according to a first embodiment of the present invention. The wireless communication apparatus constitutes a mobile communication terminal, which is powered by a battery, for example, and includes a power amplifier module 1, a memory unit 2 and a control unit 3. The power amplifier module 1 is provided with amplifiers 11 to 14 and switches 15, 16 serving as selection units. By switching between amplifiers 13, 14, which are at final stages, by use of the switches 15, 16, a first amplification path A1 including three stages of amplifiers 11, 12, 13 or a second amplification path A2 including three stages of amplifiers 11, 12, 14 is selectively constituted.

The three stages of amplifiers 11, 12, 13 located in the first amplification path A1 and three stages of amplifiers 11, 12, 14 located in the second amplification path A2 are designed such that the amplifier at a latter stage has amplification characteristics of higher linearity than that of the amplifier at a former stage. Moreover, the amplifier 13 at the final stage of the first amplification path A1 is configured to have high linearity and a backoff to be able to amplify a signal without causing a distortion even when communication is performed with all the subcarriers. In contrast, although being configured to have a similar gain as that of the amplifier 13 at the final stage of the first amplification path A1, the amplifier 14 at the final stage of the second amplification path A2 is configured to have lower linearity and backoff than those of the amplifier 13. Thus, the amplifier 14 consumes less power than the amplifier 13.

In the present embodiment, an amplification mode by the first amplification path A1 having the amplifiers 11, 12, 13 is defined as a normal mode, whereas the amplification mode by the second amplification path A2 having the amplifiers 11, 12, 14 is defined as a power saving mode.

The memory unit 2 stores the amplification paths of the power amplifier module 1 to be used in accordance with the number of subcarriers. In the present embodiment, the memory unit 2 stores a threshold (lower limit) of the number of subcarriers for using the first amplification path A1.

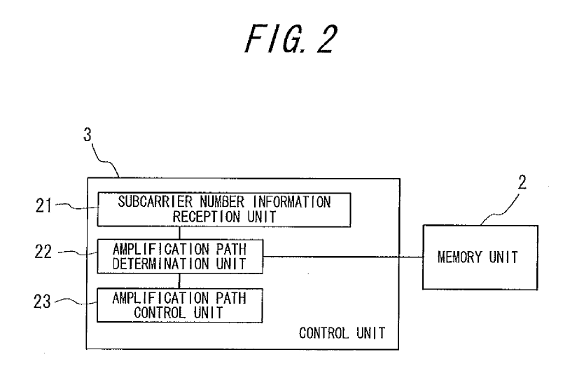

As shown in FIG. 2 which illustrates a constitution of a main part of a control unit 3, the control unit 3 is provided with a subcarrier number information reception unit 21, an amplification path determination unit 22 and an amplification path control unit 23.

The subcarrier number information reception unit 21 receives information on the number of subcarriers to be used for transmission assigned by an upper control unit (not shown) or a base station, that is, information on the number of subcarriers in the modulated signal to be input to the power amplifier module 1, in accordance with a traffic condition, a radio propagation condition, a communication usage (a voice call or a data communication), and the likes.

The amplification path determination unit 22 determines the amplification path based on information on the number of subcarriers received by the subcarrier number information reception unit 21 and information stored by the memory unit 2. The amplification path control unit 23 selects the first amplification path A1 or the second amplification path A2 by selecting the amplifier 13 or the amplifier 14 by control of the switches 15, 16 based on a result of a determination by the amplification path determination unit 22. The control unit 3 controls so as to stop an operation of the amplifier 14 when the amplifier 13 is selected by the switches 15, 16, whereas, when the amplifier 14 is selected, the control unit 3 controls so as to stop an operation of the amplifier 13.

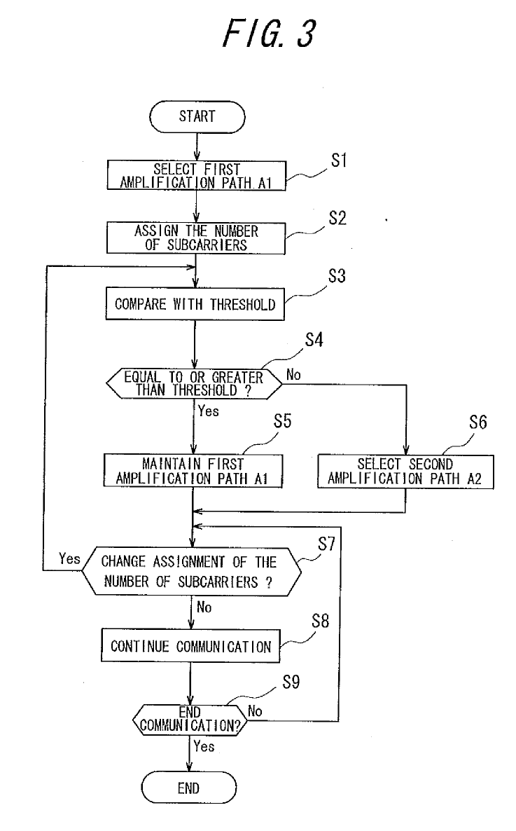

The following describes about operations of the wireless communication apparatus according to the present embodiment, with reference to a flow chart shown in FIG. 3.

First, immediately after start of the communication, the control unit 3 selects the first amplification path A1 of the power amplifier module 1 as a default. Specifically, the control unit 3 selects the amplifier 13 via the switches 15, 16 by the amplification path control unit 23 and thereby an input modulated signal is amplified in the normal mode through the first amplification path A1, constituted of the amplifiers 11, 12, 13, and then transmitted (step S1).

Then, the number of subcarriers to be used is assigned in accordance with a communication condition and a usage (step S2), and when the subcarrier number information reception unit 21 of the control unit 3 receives information on the number of subcarriers to be used, that is, information on the number of subcarriers in the input modulated signal, the amplification path determination unit 22 compares the number of subcarriers to be used and the threshold stored in the memory unit 2 (step S3) and determines whether the number of subcarriers to be used is equal to or greater than the threshold (step S4).

When the number of subcarriers to be used is equal to or greater than the threshold as a result, the amplification path control unit 23 maintain the power amplifier module 1 with the first amplification path A1 as the default, so that the power amplifier module 1 power-amplifies the input modulated signal in the normal mode and continues the communication (step S5).

In contrast, when the number of subcarriers to be used is smaller than the threshold, the amplification path control unit 23 switches to the second amplification path A2 of the power amplifier module 1 and continues the communication (step S6). That is, when the number of subcarriers to be used is smaller than the threshold, the amplification path control unit 23 selects the amplifier 14 via the switches 15, 16. Thereby, the input modulated signal is power-amplified in the power saving mode through the second amplification path A2 constituted of the amplifiers 11, 12, 14, and then transmitted.

Subsequently, the control unit 3 determines whether there is a change in assignment of the number of subcarriers based on the number of subcarriers received by the subcarrier number information reception unit 21 (step S7). When there is a change, the control unit 3 returns to step S3 and repeats operations stated above. When there is no change, the control unit 3 maintains the amplification mode at that time and continues the communication (step S8). Then, the control unit 3 continues the communication by returning the process to step S7 until the communication ends at step S9.

As described above, when the number of subcarriers in the modulated signal to be power-amplified is equal to or greater than the threshold, the wireless communication apparatus according to the present embodiment amplifies the input modulated signal in the normal mode by the first amplification path A1 which includes the amplifier 13 having high linearity and backoff to be able to amplify the signal without causing the distortion even when the communication is performed by use of all of the subcarriers. In contrast, when the number of subcarriers in the modulated signal is less than the threshold, the wireless communication apparatus amplifies the input modulated signal in the power saving mode by the second amplification path A2 which includes the power amplifier 14 having lower linearity and backoff than those of the amplifier 13. It is thus possible to reduce power consumption effectively without negatively affecting the communication. Therefore, it is more effective for the mobile communication terminal which has a battery life as a significant issue. Moreover, since it necessitates only a comparison of the number of subcarriers in the modulated signal and the threshold for a selection between the first amplification path A1 and the second amplification path A2, the selection may be easily performed.

### Second Embodiment

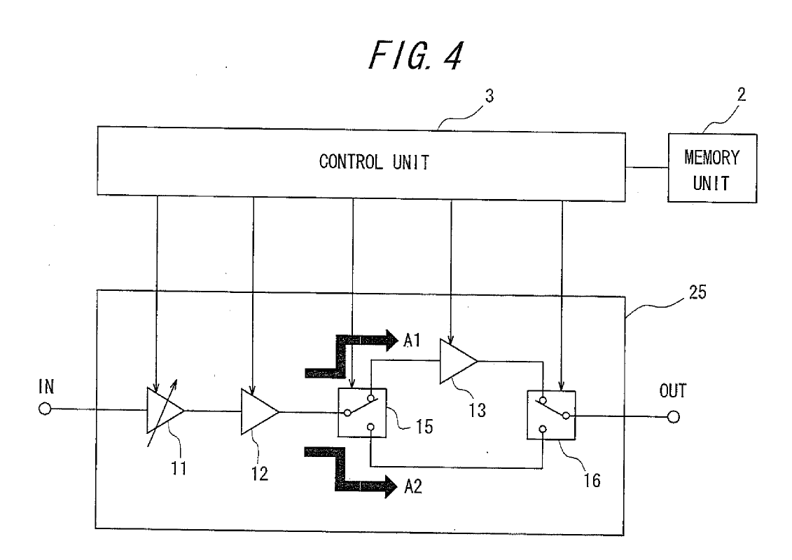

FIG. 4 is a block diagram illustrating a constitution of a main section of a wireless communication apparatus according to a second embodiment of the present invention. In the wireless communication apparatus according to the present embodiment, a power amplifier module 25 is designed by removing the amplifier 14 in the power amplifier module 1 shown in FIG. 2. Specifically, the first amplification path A1 is constituted of the three stages of the amplifiers 11, 12, 13 in the same manner as the wireless communication apparatus according to the first embodiment, and the second amplification path A2 is constituted of two stages of the amplifiers 11, 12 by bypassing the amplifier 13 at the last stage of the first amplification path A1 by the switches 15, 16. In addition, the amplifier 11 at the first stage constituting the first amplification path A1 and the second amplification path A2 has a variable gain to be able to adjust an entire gain in each of the paths.

In the similar manner as the first embodiment, when the number of subcarriers in the modulated signal to be power-amplified is equal to or greater than the threshold, the wireless communication apparatus according to the present embodiment amplifies the input modulated signal in the normal mode by the first amplification path A1 which includes the amplifier 13 having high linearity and backoff so as to be able to amplify the signal without causing the distortion even when the communication is performed by use of all of the subcarriers, and transmits the signal. In contrast, when the number of subcarriers in the modulated signal is less than the threshold, the input modulated signal is amplified in the power saving mode by the second amplification path A2 constituted of the two stages of the amplifiers 11, 12 by bypassing the amplifier 13. At this time, the control unit 3 stops the operation of the amplifier 13 as well as controlling a gain of the amplifier 11 at the first stage so as to obtain a desired gain. Other constitutions and operations are the same as those of the wireless communication apparatus according to the first embodiment.

Accordingly, the wireless communication apparatus according to the present embodiment is capable of efficiently reducing power consumption without negatively affecting the communication, in a similar manner as the wireless communication apparatus according to the first embodiment. In addition, since the second amplification path A2 in the wireless communication apparatus according to the present embodiment is constituted by bypassing the amplifier 13 at the last stage of the first amplification path A1, it has an advantage to be able to implement the power amplifier module 25 more simply and at a lower cost comparing to the first embodiment.

### Third Embodiment

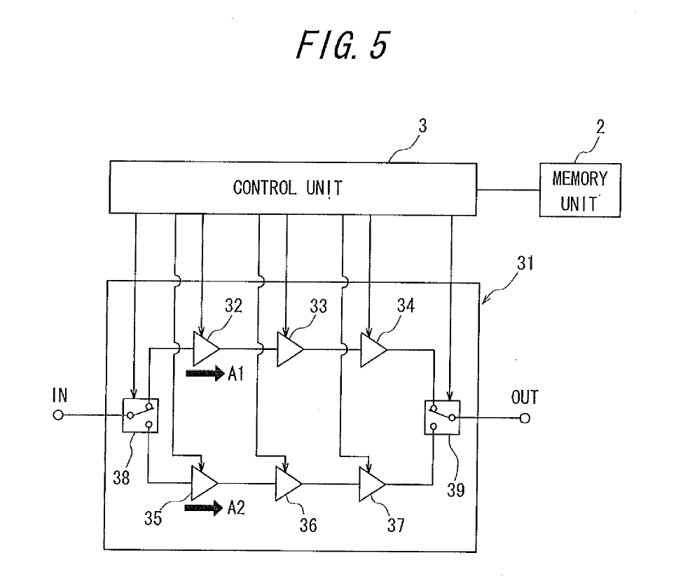

FIG. 5 is a block diagram illustrating a constitution of a main section of the wireless communication apparatus according to a third embodiment. The wireless communication apparatus according to the present embodiment is provided with a power amplifier module 31 having the first amplification path A1 which includes three stages of amplifiers 32, 33, 34, the second amplification path A2 which includes three stages of amplifiers 35, 36, 37, and switches 38, 39 which serve as a selection unit for switching between the amplification paths.

The first amplification path A1 is designed to have high linearity and backoff so as to be able to amplify the signal without causing the distortion even when the communication is performed by use of all of the subcarriers. The second amplification path A2 is designed to have lower linearity and backoff than those of the first amplification path A1, so as to consume less power than the first amplification path A1. In addition, the switches 38, 39 are controlled to select the first amplification path A1 as the default. Each of the first amplification path A1 and the second amplification path A2 is controlled such that corresponding amplifiers operate when being selected by the switches 38, 39, and do not operate when being not selected.

When the number of subcarriers in the modulated signal to be power-amplified is equal to or greater than the threshold, the wireless communication apparatus according to the present embodiment amplifies the input modulated signal in the normal mode by the first amplification path A1 which has high linearity and backoff in the same manner as the first embodiment, and transmits the signal. In contrast, when the number of subcarriers in the modulated signal is less than the threshold, the second amplification path A2 is selected by the switches 38, 39 so as to amplify the input modulated signal in the power saving mode. Other constitutions and operations are the same as those of the wireless communication apparatus according to the first embodiment. Thus, the wireless communication apparatus according to the present embodiment is capable of reducing power consumption efficiently without negatively affecting the communication, in a similar manner as the wireless communication apparatus according to the first embodiment.

It is to be understood that the present invention is not limited to the above embodiments but may be modified or changed in a variety of manners. It is also possible, for example, to make a selection between the first amplification path A1 and the second amplification path A2 in consideration of not only the number of subcarriers to be used but also transmission power and a modulation class. For example, when the number of subcarriers to be used is equal to or greater than the threshold, the input modulated signal is amplified in the normal mode regardless of the transmission power. In contrast, when the number of subcarriers to be used is less than the threshold, the input modulated signal is amplified in the normal mode when the transmission power is equal to or more than the predetermined value, or amplified in the power saving mode when the transmission power is less than the predetermined value. Moreover, the number of the amplification paths is not limited to two, but three or more amplification paths with different power consumption can be provided, and a suitable one is selected in accordance with the number of subcarriers in the modulated signal. Furthermore, although the present invention is particularly effective for the mobile communication terminal powered by a battery, it is also effectively applicable to a fixed wireless communication apparatus such as the base station and the likes.

1. A wireless communication apparatus for transmitting a multi-carrier modulated signal comprising:
at least two amplification paths with different power consumption and capable of amplifying the modulated signal;
a selection unit for selecting one of the at least two amplification paths; and
a control unit for controlling the selection unit to select one of the amplification paths in accordance with a number of subcarriers in the modulated signal, and a selected amplification path to amplify the modulated signal.

2. The wireless communication apparatus according to claim 1, further comprising a memory unit for storing an amplification path to be used in accordance with the number of subcarriers,
wherein the control unit controls the selection unit to select a corresponding amplification path stored in the memory unit, in accordance with the number of subcarriers in the modulated signal.

3. The wireless communication apparatus according to claim 1, wherein the control unit controls the selection unit to select one of the amplification paths in accordance with the number of subcarriers and transmission power for transmitting the modulated signal.

4. The wireless communication apparatus according to claim 1, wherein among the at least two amplification paths with different power consumption, an amplification path with less power consumption has an amplification characteristic of lower linearity than that of an amplification path with more power consumption.

5. The wireless communication apparatus according to claim 1, wherein among the at least two amplification paths with different power consumption, an amplification path with more power consumption has an amplification characteristic of higher linearity than that of an amplification path with less power consumption.

6. A transmission control method of a wireless communication apparatus for transmitting a multi-carrier modulated signal comprising:
an amplification path selection step for selecting one amplification path or another amplification path with less power consumption than the one amplification path to amplify the modulated signal in accordance with a number of subcarriers in the modulated signal; and
a modulated signal amplification step for amplifying the modulated signal by a selected amplification path.
